(19) United States
(12) Patent Application Publication
(10) Pub. No.: US 2002/0156727 A1
(43) Pub. Date: Oct. 24, 2002

(54) Method and apparatus for conducting live, point-of-sale, electronic monitoring and transaction services

(76) Inventors: Mark LeVake, Colorado Springs, CO (US); Travis Toler, Florissant, CO (US); Jon Egan, Denver, CO (US); Randy Crupper, Palmer Lake, CO (US); Rodney Young, Colorado Springs, CO (US); Aaron Danis, Colorado Springs, CO (US)

Correspondence Address: MINTZ, LEVIN, COHN, FERRIS,, GLOVSKY and POPEO, P.C., One Financial Center, Boston, MA, 02111, US

(21) Appl. No.: 10/059,939

(22) Filed: Jan. 29, 2002

Related U.S. Application Data
(60) Provisional application No. 60/264,752, filed on Jan. 29, 2001.
(60) Provisional application No. 60/311,519, filed on Aug. 9, 2001.
(60) Provisional application No. 60/350,180, filed on Oct. 26, 2001.

(51) Int. Cl. G06F 17/60

(52) U.S. Cl. 705/39; 705/64

(57) ABSTRACT

A system and method for managing information from a point-of-sale/usage device includes a remote computer in communication with a computer network, the remote computer having a database for storing information obtained from a point-of-sale/usage device, and a wireless data network in communication with the computer network. The point-of-sale/usage device includes a controller for managing operation of the point-of-sale/usage device and having memory for storing information related to the operation of the point-of-sale/usage device and information related to purchases of a product and/or service, an interface for transferring data from the controller and an Enabler device. The Enabler device includes a wireless data network transceiver linked to the interface, and a card reader in communication with the transceiver for entering credit card account information. The Enabler may also include a micro-controller, depending upon the configuration of the point-of-sale/usage device.

The present invention claims benefit under 35 U.S.C. § 119(e) of U.S. Provisional Patent Application Nos. 60/264,752, filed Jan. 29, 2001, 60/311,519, filed Aug. 9, 2001, and 60/______,______ , filed Oct. 26, 2001 (application number not yet available), the entire disclosures of which are herein incorporated by reference.

### BACKGROUND OF THE INVENTION

1. Field Of The Invention

The present invention relates to the use of wireless data communication and more particularly to a device which enables other devices not connected to land based telephone lines to access a computer network via a wireless data network. Moreover, the present invention also enables “live” point-of-sale electronic transactions and point-of-usage services.

2. Background of the Invention

Wireless data communications have expanded and opened up the possibility for a variety of services which were formerly not available or inconvenient. Service stations, delivery services, food services, vending machines, mobile sales, retailers, entertainment, and transportation services are can be greatly enhanced because of wireless technology.

Wireless devices in communication with a wireless network are “live”, i.e., available for instant communication with the network. Such real-time connections are especially convenient for monitoring and tracking, including, for example, tracking vehicles and the like. Wireless communications also make possible point of sale transactions using credit, debit, EBT and other types of payment cards, devices, biometrics, wireless phones and other identification elements. However, at this point in time, there has been no successful implementation of card reading devices used with point-of-sale and point-of-usage apparatuses for communication over a wireless data network.

One skilled in the art will appreciate that the present application refers to “point-of-sale” devices to be defined as any device (mobile of fixed) in which a transaction is conducted for the purchase of a product or service. In addition, the present application defines “point-of-usage” as any device (mobile or fixed) in which information is collected.

### Wireless Data Communications

Wireless data communications are processed over wireless data networks. These wireless data networks currently include Cellular Data Packet Data (CDPD), the Motient network, General Packet Radio Service (GPRS), CDMA (Code Division Multiple Access) and TDMA (time-division multiple access) as examples. CDPD and the Motient network are two of the most widely used systems, with each transmitting and receiving data in digital packet form.

Currently, wireless devices (mobile or fixed) communicate with a wireless network with a radio frequency (RF) transceiver or modem. An RF modem takes the data and converts it to radio frequencies for the particular wireless network to be received by a base station. Modems are generally network specific, i.e., a modem designed for use with a CDPD network cannot be used on the Motient network.

CDPD networks operate by sending digital packet data over the same frequency spectrum as analog voice in the existing AMPS analog network (Advanced Mobile Phone Service), but with different modulation in the air interface. Analog cellular channels that are not being used for voice calls are used to transmit data. However, since voice calls have priority over data transmission, another channel must be found to transmit data when a voice transmission occurs over the channel. This problem is solved by using frequency hopping technology which allows the flow of data to continue on another channel when voice communication occurs on a channel currently being used for data transmission.

A CDPD modem configures data packets according to the popular TCP/IP Internet protocol, enabling Internet, Intranet or other networks (whether public or private) to work transparently over the CDPD network. Thus, devices configured to operate with the Internet work seamlessly with a CDPD network. TCP/IP packet data is transformed into a modulated waveform with the modem for transmission onto a physical RF channel.

Although MOTIENT networks operate using digital packet data, they operate with a different proprietary protocol than that of a CDPD network. Specifically, Native Control Language protocol is used as a link layer protocol between the client application on the point-of-sale/usage device and the RF modem.

In order for a remote device to access a wireless network, the data must be configured in a form acceptable for transmission on the particular network (e.g., TCP/IP protocol) and also must be connected to a modem designed to operate with the network. If the remote device is a personal computer, or a device connected to a personal computer, configuring the data for a particular network is done by using available software code which allows a remote device to communicate with the modem and the wireless network.

However, providing a personal computer at a remote location, when connecting, for example, a remote monitoring system to the wireless network, creates difficulties. First, providing portable personal computers (notebook or desktop computers) so that a remote device can access a wireless network, is cost prohibitive, and completely impractical for particular devices (e.g., vending machines). Second, power must not only be supplied to the remote device, but to the computer as well, which complicates power requirements and adding additional cost factors as well.

### SUMMARY OF THE INVENTION

Accordingly, the present invention (hereinafter referred to as “the Enabler”) addresses the concerns noted above. The Enabler easily facilitates credit transactions and the transfer of data on a particular wireless network.

The present invention also provides methods of authorization and/or payment for goods and services using credit, debit, EBT or other card types. Moreover, the present invention may be used with other types of identification methods such as biometrics. Accordingly, hereinafter all such payment and authorization methods and devices will be referred as “Credit”.

Moreover, the present invention includes methods and apparatuses by which remote devices (such as vending machines) are monitored to create reporting/tracking features to an authorized user over a computer network. Such reporting/tracking features can be organized and run by a service organization, so that the service can be offered to existing organizations which have limited infrastructure and resources. For example, a Credit card company could monitor and track wireless transactions without having to setup infrastructure and designate resources for such purposes. The Credit card company would simply access the data in a report format (or any other format) over the Internet from a server of the monitoring organization.

In one aspect of the present invention, a device having hardware and software code allows a point-of-sale/usage device with a serial output device to communicate with a CDPD wireless network via a CDPD modem.

In another aspect of the present invention, a device having hardware and software code allows a point-of-sale/usage device with a serial output device to communicate with the MOTIENT wireless network via a DataTAC modem.

Not withstanding the above two aspects, the Enabler may be modified to provide data processing over any RF network or other wireless medium.

In still another aspect of the present invention, a device having hardware and software code allows a magnetic card reading device to input identification data for use of a point-of-sale/usage device for transmission over a wireless network. Such identification data may be Credit card information for payment of a sale at the point-of-sale/usage device for the purchase of goods and/or services.

In another aspect of the present invention, a vending machine includes a vending machine controller and an enabling device for enabling electronic payment for products dispensed from the vending machine and for communicating information between the vending machine and a remote computer. The Enabler includes a wireless data network transceiver linked to an interface of the vending machine controller, a card reader in communication with the transceiver for entering Credit card account information and a micro-controller in communication with the transceiver and the interface.

In yet another aspect of the present invention, a system for managing information from a vending machine includes a remote computer in communication with a computer network, the remote computer having a database for storing information received from a vending machine, a wireless data network in communication with the computer network and a vending machine. The vending machine includes a vending machine controller for managing operation of the vending machine and having memory for storing information related to the operation of the vending machine and information related to at least one of the inventory of vended product and sales of the vended product, an interface for transferring data from the vending machine controller and an Enabler. The Enabler includes a wireless data network transceiver linked to the interface, a card reader in communication with the transceiver for entering Credit card account information and a micro-controller in communication with the transceiver and the vending machine controller.

In still yet another aspect of the present invention, a method for monitoring inventory in a vending machine includes providing a vending machine having a vending machine controller including a memory for storing transaction information, with the vending machine capable of vending preloaded product having a unique identification from a known inventory of the product and having a predetermined selling price, wherein in response to a request from a buyer and upon tendering payment equal to or greater than the predetermined selling price, the vending machine having the capability to create data representative of the unique product identification, and the time of any vending event, and method of payment of such event. The method also includes providing a communication link between the vending machine and a remote computer on a computer network via a wireless data network, creating a data record of all vending events, storing a plurality of the data records in the memory and transmitting the plurality of data records to the remote computer via said wireless data network.

In another aspect of the present invention, a method for managing information from a vending machine includes sending a first request from a remote computer on a computer network to a remote vending machine via a wireless data network, the request for vending machine data being stored in a database in the vending machine and forwarding the data from the vending machine to the remote computer in response to the request via the wireless data network.

In another aspect of the present invention, a method for updating a transaction information in a remote point-of-sale device includes providing a point-of-sale device having a controller in communication with a wireless transceiver for communicating with a remote computer on a computer network via a wireless data network, sending a command from the remote computer to the point-of-sale device, the command for changing transaction information of the database with new information, sending the new information from the remote computer and storing the new information in the database.

In another aspect of the present invention, a method of settling a Credit Transaction from a point-of-sale device includes entering Credit account information into a point-of-sale device for conducting a purchasing transaction for a product and/or service, authenticating the account information, where upon the account information being authentic, the method further includes determining the availability of memory space to store transaction information necessary to settle the transaction with a Credit company issuing the Credit account, storing the transaction information necessary to settle the transaction in the memory space when the memory space is available, and settling the transaction with the Credit company at a predetermined later time.

In yet another aspect of the present invention, a point-of-sale device includes a controller and an enabling device for enabling electronic payment for purchases from the point of sale device and for communicating information between the point of sale device and a remote computer, the Enabler including a wireless data network transceiver linked to an interface of the controller, a card reader for entering Credit card account information, the reader in communication with the transceiver, and a micro-controller in communication with the transceiver and the interface of the controller.

In still yet another aspect of the present invention, a system for managing information from a point-of-sale device includes a remote computer having a database for storing information from a point-of-sale device, the remote computer in communication with a computer network, a wireless data network in communication with the computer network, and a point of sale device. The point of sale device includes a controller for managing operation of the point of sale device and having memory for storing information related to the operation of the point of sale device and information related to purchases of a product and/or service, an interface for transferring data from the controller, and an Enabler device. The Enabler includes a wireless data network transceiver linked to the interface, a card reader for entering Credit card account information, the reader in communication with the transceiver, and a micro-controller in communication with the transceiver and the controller.

In another aspect of the present invention, a method for managing information from a point-of-sale device includes sending a first request from a remote computer on a computer network to a remote point of sale device, where the request for at least one of transaction and telemetry data stored in a database in the point-of-sale device and the request is sent to the point-of-sale device via a wireless data network. The method also includes forwarding the data from the point of sale device to the remote computer in response to the first request.

In yet another aspect of the present invention, a method of authorizing a credit transaction from a point of sale device includes entering credit account information into a point of sale machine for conducting a purchasing transaction for a product and/or service, forwarding the Credit account information to a remote computer, forwarding the Credit account information from the remote computer to a Credit card processor host to obtain a credit approval, and transmitting the Credit approval from the Credit card processor host to the point of sale device via the remote computer.

Other aspects of the present invention include systems and computer readable media for carrying out the methods and processes described above.

### BRIEF DESCRIPTION OF THE FIGURES

These and other features, aspects and advantages of the present invention will become better understood with regard to the following description and accompanying drawings, flowcharts and screen shots where:

FIG. 1 is a block diagram illustrating an Enabler device according to the present invention.

FIG. 2 is a block diagram illustrating a vending machine controller and associated devices used in a vending machine for the purchase of products.

FIG. 3 is a block diagram illustrating the connections between a vending machine controller and the Enabler device according to the present invention.

FIG. 4 illustrates an overview of a system for remotely monitoring remote vending devices using the communication device according to the present invention.

FIGS. 5A and 5B illustrates a process flow for handling procedures for one embodiment according to the present invention.

FIG. 6 illustrates a process flow for processing Credit Transactions using the communications device according to the present invention.

### DETAILED DESCRIPTION OF THE PREFERRED EMBODIMENTS

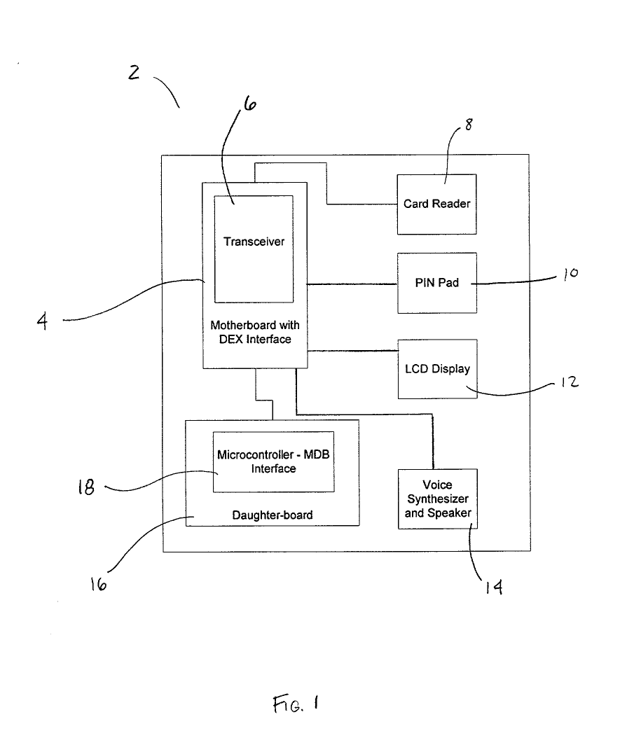

The preferred embodiments of the present invention will now be described in detail with references to FIGS. 1 through 6. Although the systems and methods of the present invention will be described in connection with these preferred embodiments and drawings, it is not intended to be limited to the specific form set forth herein, but on the contrary, it is intended to cover such alternatives, modifications, and equivalents, as can be reasonably included within the spirit and scope of the invention.

The present invention may be used to communicate information between a remote computer and a point-of-sale device. Such point-of-sale devices include vending machines, taxi meters, jukeboxes, Kiosks (in general), and the like.

Ideally, the present invention is particularly well suited for use with a DEX enabled vending machine and will be described with reference to such a machine. However, as will be discussed later in this specification, the present invention is broadly applicable for forwarding information and processing Credit transactions for any point-of-sale or point-of-usage device.

Direct Exchange, or DEX as it is better known, is a protocol for the transfer of information from a vending machine to a data collection device. The data is typically stored in a vending machine electronic controller. The DEX standard determines how a number of established information elements, such as price and sales of a certain product, are transferred. This is also referred to as data “formatting.” The formatting uses an agreed-upon numbering system which includes more than 350 information elements. Prior to the present invention, depending upon the collection device, the connection between the vending machine and the data collector is currently established by means of a plug, an optical interface or an infrared communication.

Accordingly, DEX data relates to transactions, sales, cash collections, product movement and other vending machine activities and is currently stored in a memory of the vending machine controller for later collection with a collection device by route personnel —i.e., personnel who, on a recurrent basis, visit the vending machine to download the data and restock inventory.

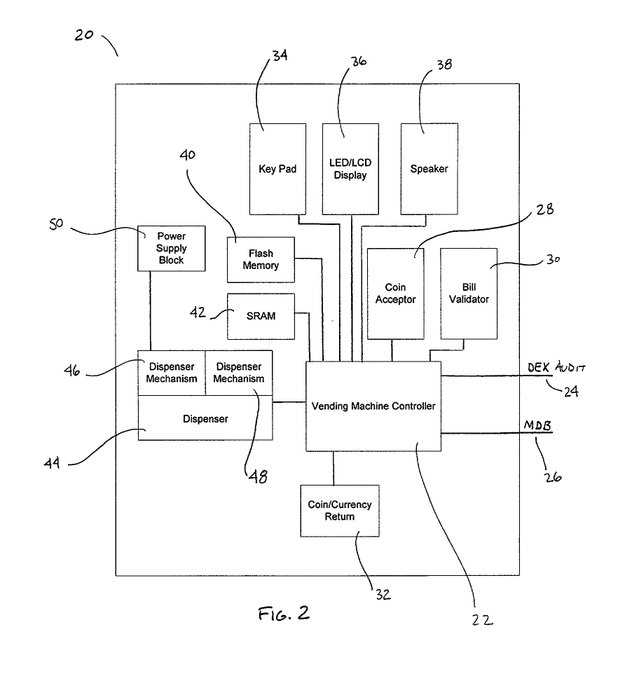

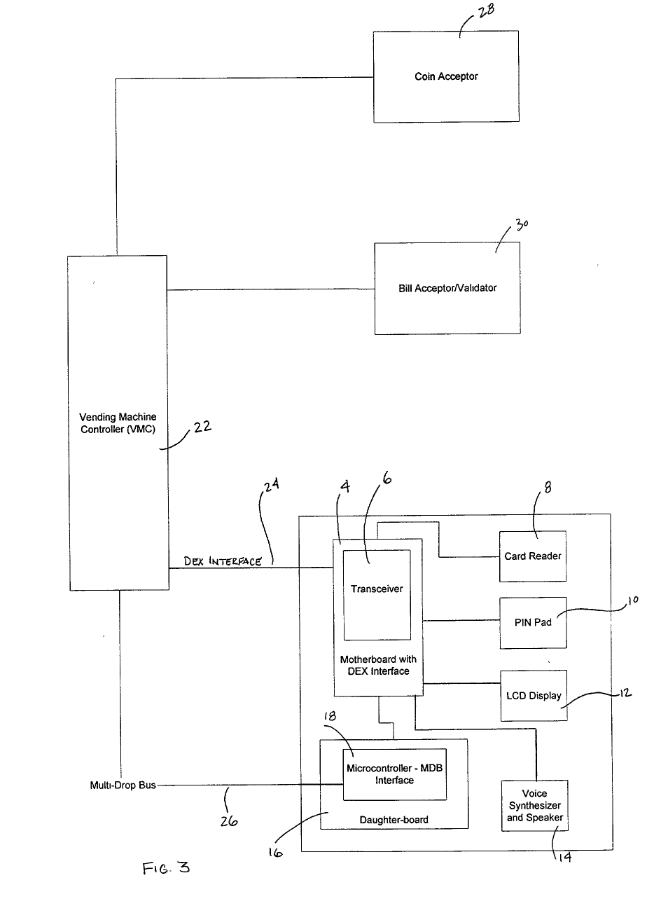

As shown in FIGS. 2 and 3, typically, a DEX enabled vending machine 20 includes a vending machine controller (VMC) 22, which controls the basic operation of the vending machine. Such operation primarily concerns actuating dispenser motors 46 and 48 of the dispenser area 44 for moving product to a delivery area in the vending machine in response to a selection made by a customer after payment of a sales prices for the particular item vended. The VMC is in communication with other devices of the vending machine which allow for the payment, change, selection, dispensing, and storage of data. These devices includes a key pad 34, for selecting a product, and a display 36 generally for viewing selection information and payment entered into the vending machine prior to selection. The display may also be used to display advertising and/or any other information. Currency acceptor mechanism such as a coin acceptor 28, a bill validator 30 and a coin return 32 are also in communication with the VMC, as are memory, which may include both Flash read-only-memory 40 and random-access memory 42. A power supply 50, provides power, preferably DC, to the various components, most likely the VMC and the dispenser mechanics. A speaker 38, may be included, for example, to play advertisements and to instruct purchasers on the operation of the vending machine.

The VMC also includes a DEX interface 24, which, when connected to the data collection device, allows for the transfer of transaction and machine data stored in memory. As stated previously, this interface may be a mechanical connection including an optical interface, as well as an infrared port.

A Serial Bus or Multi-Drop Bus (MDB) 26 is also included on the VMC and is configured in a Master-Slave operation. There is one Master with the capability of communicating with up to thirty-two peripheral Slaves. Thus, preferably the Master is defined as the VMC, with each Slave being assigned a unique address and command set. The Master will poll the bus for Slave activity and respond with acknowledgement, negative acknowledgement or specific data dependant on its current activity. If a Slave does not respond within a predefined time it is assumed that it is not present on the bus. Bus interference and crashes are prevented because each Slave only responds upon being polled. The Master initiates all communication and since there is only one Master, bus crashes are easily precluded. To that end, all Slaves will recognize a disable command or commands sent by the Master to allow for disabling of individual Slaves for various reasons (for example power management techniques). Error checking and correction is accomplished by using checksums (CHK) and a retransmit command.

An Enabler 2 for wirelessly transferring data and performing Credit transactions according to the present invention is illustrated in FIGS. 1 and 3. The Enabler allows DEX information, machine metrics information (e.g., security, tampering, temperature of product) to be forwarded over a wireless data network to a remote computer and also allows for Credit Transactions to be conducted on the point-of-sale device. The Enabler implements corresponding processes for monitoring, tracking, diagnostics, maintenance and data collection of the remote vending machine. Additionally, the Enabler allows Credit Transactions to be conducted on the vending machine (or any point-of-sale device).

The Enabler 2 generally includes a mother-board 4 having a wireless transceiver 6 (which may be network specific e.g., CDPD, CDMA, DataTAC, Mobitex and TDMA, etc.), and memory (not shown—preferably both read-only memory and random-access memory. The mother board is connected with the DEX interface 24 of the Vending Machine Controller (VMC) 22. A daughter-board 16 is also included with the Enabler and includes a micro-controller 18 which is connected to the MDB of the VMC.

The Enabler's mother-board 4 preferably also includes an External Power Reset Timer circuit (not shown). This circuit functions to perform a complete power OFF then power ON reset independent of the firmware controlling the Enabler if the Enabler firmware were to lockup for any reason. Specifically, there are two timer circuits for powering ON the Enabler. The first, an External Power Reset Timer, includes a reset timeout value for resetting power when a predetermined period of time (e.g., five minutes) elapses. The second, a power ON timer on the Enabler, resets power in a smaller period of time (e.g., four seconds). For example, once power is applied to the Enabler, both timers start at reset (zero). In four seconds the power ON timer triggers the power circuits to turn ON. The Enabler firmware then boots up and controls the External Power Reset Timer by resetting it at random intervals, but intervals less than five minutes. If for some reason the Enabler firmware locks up, then the External Power Reset Timer will not receive the reset from the Enabler, but will timeout (overflow) and reset the power ON timer, thus cycling power OFF then ON.

The Enabler, depending upon its use, may also include a magnetic card reader 8, L.E.D. power and signal strength indicators, as well as a Personal Identification Number pad 10 for inputting a PIN number by a customer, a display 12 and a voice synthesizer/speaker 14 for guiding a transaction or broadcasting music and/or other information..

In a preferred embodiment, the Enabler includes a display and magnetic card reader mounted to a metal bracket that mounts as an assembly in the vending machine. The display and magnetic card reader derive their power from the Enabler, with the display receiving data from the Enabler and the magnetic card reader sending data to the Enabler.

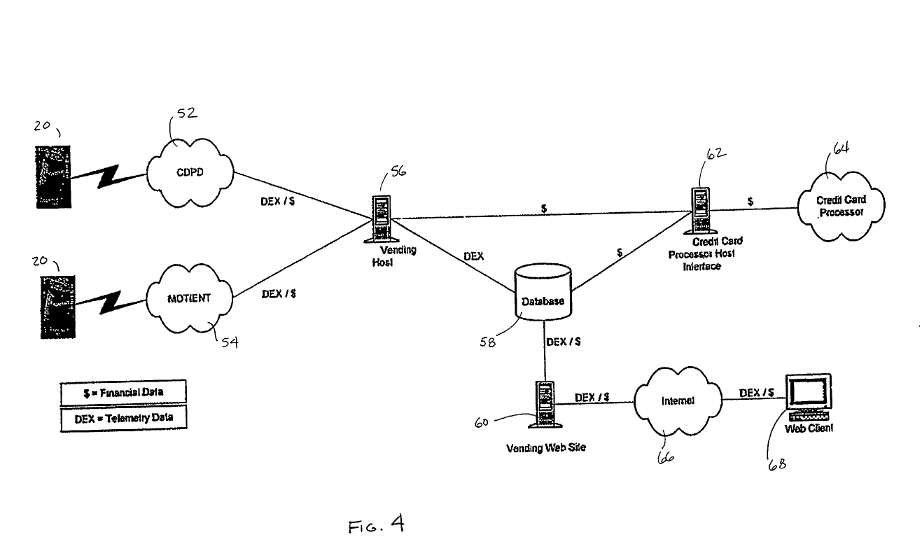

FIG. 4 illustrates the use of the Enabler on a vending machine network. As shown, vending machines 20 transfer data upon request to a vending host computer 56 via a wireless network (shown with both CDPD network 52 and Motient network 54). From there, the data is stored in a database 58. Credit data is sent by a Credit card processor host 62 to the appropriate Credit card company settlement network settlement 64. DEX information is available from a vending website host 60, for individual clients (i.e., route personnel, vending machine company) to access via a web client 68.

### Collection of Data

In response to commands received wirelessly from a remote computer, the Enabler retrieves DEX data from the vending machine and transmits the data wirelessly to the remote computer for processing. This data can be processed and organized to yield various reports on the transactions conducted at the machine, as well as the status of the machine. Such data is invaluable for tracking inventory and restocking the vended product, since route personnel know exactly how many items require to be refilled. Thus, route personnel do not have to bring all quantities of all products available for purchase, just those which have been depleted.

In a preferred embodiment, the Enabler allows vended product to be purchased using Credit cards. Payment of product using hard currency may be still handled by the VMC, although the present invention may be configured such that currency acceptance mechanisms are operated through the Enabler.

### Enabler Mechanics

In one embodiment of the present invention, the Enabler is housed in a rectangular box that can be mounted either vertically or horizontally within a vending machine using a keyhole bracket, similar to the pattern on the back of a wall-mounted telephone. Due to its small size and modular design, it can be located wherever there is space inside the door of the vending machine. The Enabler housing also preferably includes a male and a female db9 connector to connect a swipe reader and DEX cable for connection to the DEX interface of the VMC. The Enabler also includes a modular phone jack connector for connecting a display cable, a MMCX connector for an antenna, and preferably two indicator lights. The first light is red and is used to indicate that power is being received by the Enabler. The second light is green and is used to indicate that there is wireless coverage for the transceiver. A standard MDB-Y cable is also be included for connecting the Enabler to the VMC's MBD bus.

### Forwarding of Data

As previously stated, the Enabler allows various procedures to be conducted from a remote computer with access to a computer network. On a daily or weekly basis, for example, the remote computer may request of a particular vending device audit/transaction data (e.g., DEX data and/or Credit transaction data). Other data may also be requested and forwarded to the remote computer including information related to the operation of the machine, and any errors which which have occurred.

Accordingly, below is a list of commands that may be sent to the Enabler from the remote computer for performing certain tasks. Each command initiates the associated process, the instructions of which are stored in a memory of the Enabler device (either memory on the mother board and/or daughter board, but preferably the mother board).

| | |
|---|---|
| DEXALL: | Transmit entire DEX audit buffer back to the remote |
| | computer. |
| DEXPDU: | Divide DEX audit buffer into as many 256-byte |
| | packets (Protocol Data Units, or PDUs) as can be |
| | constructed. |
| DEXRESET: | Zero clearable DEX fields |
| DEXCONFIG: | Writable fields are updated with data received from the |
| | remote computer via transceiver. |
| BATCHALL: | This command is sent by the remote computer to the |
| | Enabler to retrieve a Credit card batch, i.e., all Credit |
| | transactions stored in the non-volatile transaction |
| | database. This includes the normal sequentially stored |
| | transaction database and the checked transaction |
| | database, consisting of multiple transactions on the |
| | same Credit card number that have been limit checked |
| | but not settled (see limit checking procedure). An |
| | end-of-batch record will follow the transmitted batch. |
| | The remote computer will respond to the end-of-batch |
| | record with a BATCH ACK command (see below). |
| | The absence of an end-of-batch record within a |
| | designated time will cause the remote computer to |
| | send a BATCH NAK command (see below). |
| GETERROR: | This command is sent by the remote computer to the |
| | Enabler to retrieve the Enabler's error log. The error |
| | log's size, n, is configurable so that the most recent n |
| | errors will be logged. An end-of-error log record will |
| | follow the transmitted error log entries. The remote |
| | computer will respond to the end-of-error log record |
| | with an ERRORLOG ACK command (see below). The |
| | absence of an end-of-error log record within a |
| | designated time will cause the remote computer to |
| | send an ERRORLOG NAK command (see below). |
| LOADTIME: | This command is sent by the remote computer to the |
| | Enabler to update the actual time and date and |
| | synchronize with the remote computer clock. |
| ONLINE: | This command is sent by the remote computer to the |
| | Enabler to set card processing mode to ONLINE (live |
| | transactions). |
| OFFLINE: | This command is sent by the remote computer to the |
| | Enabler to set card processing mode to OFFLINE |
| | (batch transactions). |
| BADCARD: | This command is sent by the remote computer to the |
| | Enabler to update the list of invalid Credit cards in the |
| | non-volatile database. In the current embodiment, |
| | existing database is deleted before updating with new |
| | bad card entries. As an option, the system may be |
| | modified to only upload changes in order to minimize |
| | wireless air time. |
| DVRLIST: | This command is sent by the remote computer to the |
| | Enabler to update the list of valid driver cards in the |
| | non-volatile database. The existing database is deleted |
| | before updating with new driver card entries. Also as |
| | an option, the system may be modified to only upload |
| | changes in order to minimize wireless airtime. |
| TIMER: | This command is sent by the remote computer to the |
| | Enabler to replace any or all of the configurable fields |
| | (e.g., timer timeout values and Credit limit values) |
| | with new data. |
| MESSAGE: | This command is sent by the remote computer to the |
| | Enabler to replace a message in the display message |
| | database with a new display message. |
| DEX ACK: | Indication by the remote computer that information |
| | was successfully received from Enabler. |
| DEX NAK: | Indication by the remote computer that information |
| | was not successfully received from Enabler. |
| BATCH ACK: | This command is sent by the remote computer to the |
| | Enabler when a BATCHALL command is in progress |
| | and an end-of-batch record is received by the remote |
| | computer, indicating that the entire Credit batch has |
| | been successfully received by the remote computer. In |
| | the case of a nightly (or otherwise timed) batch |
| | settlement, (NOT a driver settlement) the transaction |
| | and checked transaction databases are cleared of all |
| | entries. |
| BATCH NAK: | This command is sent by the remote computer to the |
| | Enabler when a BATCHALL command is in progress |
| | and a batch record receipt timeout occurs and/or an |
| | end-of-batch record is not received by the remote |
| | computer. In the case of a driver settlement, the entire |
| | settlement package is re-transmitted to the remote |
| | computer. In the case of a nightly (or otherwise timed) |
| | batch settlement, the BATCHALL command is re- |
| | executed. |
| ERRORLOG | This command is sent by the remote computer to the |
| ACK: | Enabler when a GETERROR command is in progress |
| | and an end-of-error log record is received by the |
| | remote computer, indicating that the entire error log |
| | has been successfully received by the remote |
| | computer. The error log database is then cleared of |
| | entries. |
| ERRORLOG | This command is sent by the remote computer to the |
| NAK: | Enabler when a GETERROR command is in progress |
| | and a error log record receipt timeout occurs and/or an |
| | end-of-error log record is not received by the remote |
| | computer. In this case, the GETERROR command is |
| | re-executed. |
| SETTLEMENT | Indication by the remote computer that entire |
| ACK: | settlement process has been completed. |
| SETTLEMENT | Indication by the remote computer that there are |
| NAK: | inconsistencies in the settlement data. |
| POWERUP: | This command is sent by the host to the Enabler to |
| | initiate a soft reset of the modem and restart the |
| | application. |
| CLEARDB: | Causes the database to be deleted as a diagnostic |
| | capability. |

Generally, a DEX data transfer period is established whereupon data from a particular vending machine is forwarded to the remote computer. The period may be predetermined, such that the data is forwarded when a set number of hours, days, weeks or months elapse. Alternatively, the data may be forwarded upon the occurrence of an event—for example, when inventory for a particular product is low, when inventory for a product runs out, when a memory holding audit data is close to being fall, or when a performance error occurs. Preferably, data is forwarded each day during a time when the vending machine is not being used (i.e., early morning hours), and is initiated by a command request forwarded to the vending machine by the remote computer. Alternatively, the Enabler may automatically contact the remote computer to initiate data transfer.

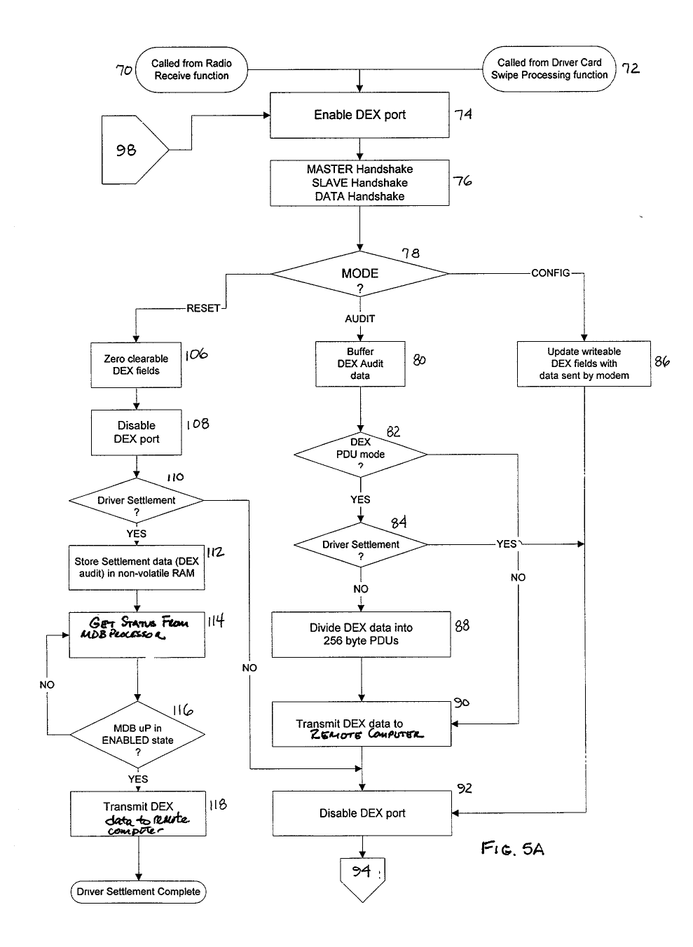

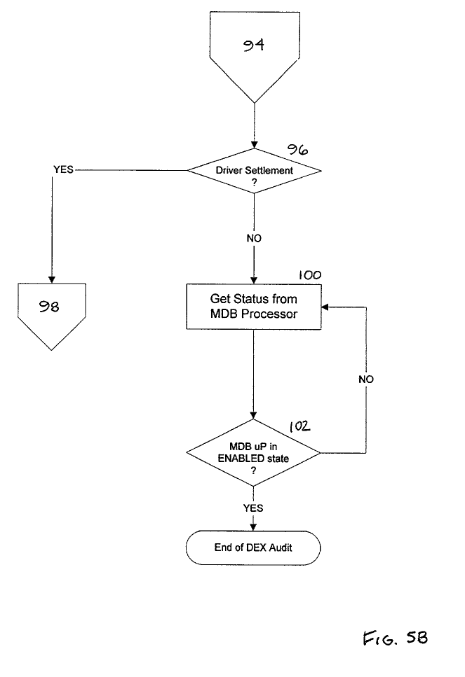

Accordingly, as outlined in FIGS. 5A and 5B, the flowcharts between the two being connected via numeral (94), data is remotely extracted from the VMC according to the following process. First, DEX audit procedures are initiated by enabling the DEX port (74) of the Enabler in response to a request (70) received wirelessly from the remote computer. Master, Slave, and Data handshakes are then performed (76) which is implemented as a state machine—each of the send/receive “phases” in the Master, Slave, and Data exchanges being viewed as a distinct state. When the DEX port is enabled, the MDB of the vending machine controller, as seen by the Enabler's micro-controller, is disabled to allow the VMC to exclusively handle the DEX data.

Depending upon the mode (78) of data requested (i.e., request made wirelessly or via a driver's card swipe, see steps 72, 84, 96 and 98, for example), the process proceeds in a distinct manner. For example, for a request of DEX audit data (DEXALL and DEXPDU commands), the DEX audit data is buffered in the Enabler's memory for transmission (80), then transmitted to the remote computer (90).

After the data has been forwarded by the Enabler, the remote computer may send other commands to the Enabler; such commands, for example. In the cases of a DEXRESET command (i.e., RESET mode), all clearable DEX data fields are zeroed (106). In the case of the DEXCONFIG command (CONFIG mode), the writeable fields are updated (86) with the data received from the modem. Regardless of the command, the sequence terminates with the last data exchange state. Thus, if the command is a DEXALL, the entire DEX audit buffer is transmitted back to the remote computer. If the command is a DEXPDU, the DEX audit buffer is divided (82, 88) into as many 256-byte packets (Protocol Data Units, or PDUs) as can be constructed from the complete buffer, and each PDU is transmitted to the remote computer in the sequence it was extracted in. This procedure alleviates problems with transmission of large data packets in multi-tower, high radio coverage areas.

After receiving the data, the remote computer decodes the data then transmits a DEX ACK command to the Enabler, the DEX port is disabled (92) and the Enabler's MDB processor is polled by the VMC to determine its state (100). Once the MDB processor's state is ENABLED (102), the MDB processor is ready to initiate a VEND and the Enabler's display will indicate that a Credit card may be used to obtain product.

The DEX procedures may also be initiated in response to route personnel settlement (84, 96), but includes additional measures. The process is preferably initiated by the swipe of a designated driver card (may also be initiated via a PIN input or other type of identification input). When the route personnel's identification has been validated, the data from the VMC is stored in a designated database location in a non-volatile memory of the Enabler. The Enabler now initiates a DEXPDU command (82, 88), as if it had been received wirelessly. The data is then obtained from the VMC as described above, but is not immediately transmitted back to the remote computer. Instead, the Enabler preferably initiates a DEXRESET command, zeroing the clearable DEX fields as described above and storing the DEX audit data along with the route personnel's identification data in the non-volatile memory of the Enabler. The data is then forwarded to the remote computer via PDU, with each PDU being a database record.

If conditions permit, the entire settlement database is transmitted to the remote computer wirelessly as follows. The first record, consisting of the route personnel's card data is transmitted. In response, the remote computer will respond to the receipt of this record by transmitting a DEXPDU command to the Enabler. The Enabler then transmits the remainder of the database, consisting of the DEXPDU records.

For wirelessly requested data forwarding, as well as route personnel initiated data forwarding, the remote computer transmits a DEX ACK command back to the Enabler to indicate to the Enabler that all the data was successfully received. After receiving the data, it is parsed and processed, and the remote computer transmits a SETTLEMENT ACK to the Enabler, indicating to the Enabler that the entire settlement process has been completed. The Enabler now deletes the stored database information (DEX data as well as Credit batch data), so that the memory is clear for receiving new information from future transactions.

If the entire DEX package is not received, the remote computer will transmit a DEX NAK command to the Enabler. The Enabler will respond by re-transmitting the stored settlement data again. Any other inconsistencies in the settlement data identified by the remote computer will cause the remote computer to transmit a SETTLEMENT NAK to the Enabler, thus requiring the Enabler to re-transmit the information to the remote computer.

The command CLEARDB will cause the database to be deleted as a diagnostic capability if there ever is a problem. Moreover, upon the occurrence of certain errors, the Enabler proceeds in a predetermined manner. For example, if the Enabler's wireless coverage is re-established after a loss of coverage, and a settlement was in progress, the transmission of the settlement data is restarted. If power is interrupted during transmission, transmission of the settlement data is restarted as well. If power is interrupted during the extraction of the DEX data, or any time prior to the completion of the DEXRESET command, the DEX audit data will be re-read and the DEXRESET restarted, with the data stored in the non-volatile database and the entire package transmitted back to the remote computer.

### DEX Parsing

DEX data is received by the remote computer from the Enabler in a text stream containing several records (Flat File). The data in this flat file must be split up into the logical records in the database so that it can be used in reports. The process of splitting the data up is called parsing. The remote computer has a parsing engine designed to handle the varying DEX files returned from different VMC versions and manufacturers. After parsing DEX, the data is stored in a common format in the database that can be reported in the same manor regardless of the VMC version or manufacturer.

### Credit Transactions

The Enabler allows for the purchase of vended items using Credit transactions, and thus includes a transceiver protocol between the transceiver and the MDB micro-controller of the Enabler to do so. For example, if a customer chooses to purchase via a Credit card, he is instructed to swipe his Credit card through the magnetic swipe reader. After a customer swipe, the Enabler sends the MDB micro-controller a “Get_Price” command. The MBD micro-controller then starts a session with the VMC. After the session starts, the vending machine then waits for the user to make a selection for the purchase of a product. Upon detection of a selection by the user, the MDB micro-controller creates a Price_Block. This Price_Block is then sent to the transceiver. The transceiver then determines if the customer's account is valid and whether the account has the funds to cover the current transaction. The transceiver sends a “Vend_Approved” or “Vend_Denied” accordingly, to the MDB micro-controller. At any time prior to making a selection, the customer may press the Coin Return Key, which will send a “Vend Cancelled” command to the transceiver. Additionally, when a vend is attempted after an approval from the transceiver, a “Vend Success” or “Vend Failure” is sent to the VMC. In the event of a communication failure, the transceiver may perform multiple re-tries, if necessary, so that the customer will receive product. Such multiple re-tries may be restricted to a predetermined number of re-tries, for example, three (3). Such re-tries are preferably controlled by the remote computer.

### Muti-Drop Bus

The present invention also corrects a problem that has plagued MDB operating software. Specifically, according to the Multi-Drop Bus (MDB) Version 2.0 specifications, (herein incorporated by reference) a non-response timer should be restarted to prolong the time it takes to respond to an uninterruptible communication sequence (see MDB Specification Version 2.0, pages 7-63). However, certain VMCs do not allow this to happen and thus do not operate correctly according to the specification during Vend Request/Vend Approval sequences.

The Enabler addresses this problem by dynamically changing the way it responds to MDB POLL commands after the VMC issues a Vend request packet. VMC firmware versions which do not operate correctly as described above are listed in a defined lookup table stored in ROM of the Enabler. During card reader initialization, the VMC firmware version of the system upon which the Enabler is installed is compared to problem versions of VMC firmware contained in the table lookup. If the VMC firmware version matches any table entries, the card reader will not respond to any POLLs after a Vend Request packet has been issued. On the other hand, if no matches occur, an ACK will be sent to the VMC after the Vend Request packet in order to reset the non response timer. In other words, if the VMC firmware doesn't match any entries in the table lookup, communications will occur as normal as described on page 7-63 of the above referenced MDB specification. But if the VMC firmware matches one of the entries, the firmware will not issues POLLs after a Vend Request packet. This allows proper vend functionality.

Information regarding the status of vending machines being monitored by the remote computer using the Enabler and via a wireless data network may be obtained by accessing, for example, a web site, having webpages listing the information in report form. This website may be available from the remote computer (which actually obtains the data from the vending machine), or via another server computer upon which the data has passed. Thus, route personnel may access the information prior to visiting each machine in order to determine inventory as well as any problems or errors that may have been generated. For example, the web page lists all active machines for a given company or route. For each machine listed, a date and a time of the last DEX data request is listed, as well as the date and time for the last batch process, the last DEX Reset, the last product restocking visit, and the last Maintenance visit, etc., are displayed. Each date time is color-coded for easily determination of the status of the machines.

Accordingly, in the case of Last DEX read, Last DEX Reset, Last Inventory Visit, and Last Batch Process, the date/time is white (for example) if the date / time is within 1 day of the last scheduled Batch or DEX time. If the date/time is over 1 day late but less than 5, the color is yellow (for example). If the time is over 5 days past, the color is red (for example). Thus, a white color indicates recent processes, yellow represents machines which are coming due for collection of data, and red for machines in which collection of data is preferably due.

In contrast, these colors are used in the same fashion, but for different time periods, with regard to maintenance visits. For example, in the case of last maintenance visit, the color is red if the last visit was within 24 hours. The color is yellow if the last visit was more that 24 hours but less than 5 days. The color is white if the date time is more than 5 days in the past. Thus, machines which have had recent maintenance visits are color coded with a warming color since such machines might be subject to additional maintenance since they have recently broken down. Thus, machines which have not broken down for some predetermined period of time are color coded white to indicate a machine which has operated well.

### Methods of Batch Settlement for Credit Transactions

In an offline mode, the Enabler stores transactions for future transmission to the remote computer for settling with a particular Credit card company via associated Credit card processors. There are several methods for returning this batch transaction data to the remote computer. Each method is outlined below.

The inventors have found that for customer convenience when vending product using Credit accounts using wireless Credit approvals, the approval process must generally be conducted during off-peak times. This is because wireless Credit approvals may take between ten (10) to thirty (30) seconds to obtain, but may be shorter. The bulk of this time comprising the time it takes to obtain a Credit approval. This causes problems in vending since most customers are not willing to wait extended periods of time to get product.

Wireless Credit approvals are also preferably conducted during off peak times since wireless data network access may be poor (spotty signals) or unavailable during peak vending times, and wireless air time is generally cheaper during off hours, especially during the daytime when the wireless network is generally near or at capacity for wireless phone calls. Accordingly, batch processing may be accomplished in the following ways:

Remotely Driven: In a remote driven batch settlement, the remote computer requests the “batch of data” from the Enabler at a scheduled time based on a scheduled interval (e.g., hourly, daily, weekly). Upon receiving the batch settlement request, the Enabler sends the transaction data back to the remote computer according to the processes defined previously. Once the remote computer receives all of the transactions and successfully processes them, the remote computer notifies the Enabler to delete the batched transactions.

Self-Initiated: In a self-initiated settlement, the Enabler recognizes that its transaction batch is full and notifies the remote computer. The remote computer then requests the batch from the remote computer and then proceeds in the same manor as a remote computer driven batch settlement.

Delayed Settlement: In a delayed settlement, the Enabler sends transactions back to the remote computer periodically when coverage is available. This process keeps the transaction batch from ever filling up and reduces the time needed for a complete batch settlement.

One Time Settlement: In a one-time settlement, the remote computer is directed by an individual to send a batch request to a selected Enabler. The batch settlement then occurs in the same manor as a driven settlement.

Alternatively, batch processing may also occur when a predetermined number of transactions have been conducted. Such uploads may take place concurrently during additional new transactions which may be stored in an alternative batch memory, or in the original batch memory as it becomes available during an upload process.

Since batch processing may be susceptible to user fraud (e.g., a user might attempt to purchase an item using a Credit card which is already at or exceeded its Credit limit, or has been recently stolen or a lost Credit card recently found), it is preferable that limits are placed on the amount a user can purchase with each Credit card account over a given period of time in which stored Credit transactions have yet to be uploaded. Thus, for a vending machine that dispenses soft drinks, for example, a limit may be imposed for the purchase of two bottles. Thereafter, if the user attempts to purchase a vended item, the controller (computer) operation system allows a subsequent transaction to be conducted in real time only (i.e., contacting the Credit company's network computer directly.

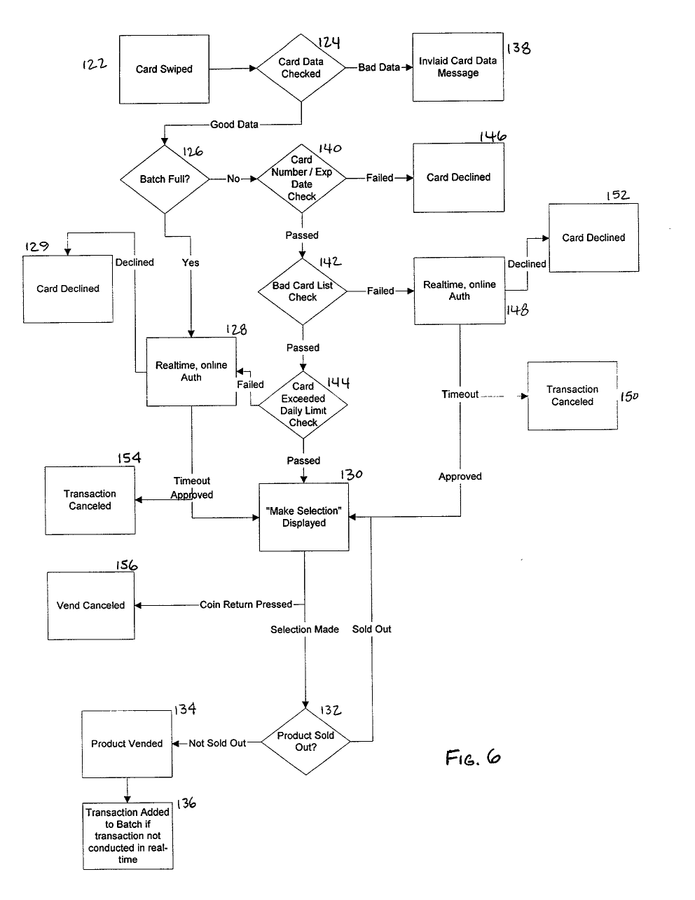

Accordingly, FIG. 6 illustrates a flowchart depicting a method for batch processing of Credit transactions according one embodiment of the present invention. Thus, initially, during a current transaction, a Credit card is swiped (122) over a magnetic swipe reader for the purchase of a vended item. The account data of the card obtained from the swipe reader is checked (124) to see if it conforms to the correct number of digits (i.e., does the Credit account number comprise sixteen (16) digits). If the account data does not contain the appropriate number of account digits, the transaction is canceled, and a message is displayed to the purchaser stating that the card data is invalid (138).

If the account number includes the appropriate number of digits (i.e., is good data), then a determination is made whether there is enough room in the batch memory for the current transaction to be saved (126). If not, then the vending machine conducts the Credit transaction in real time (Online authorization—128). During a real time transaction, if the Credit transaction is approved, a “Make Selection” is displayed to the purchaser (130) at which time a selection of the product is made. If the selected product is sold out (132), then the “Make Selection” indicator is displayed to the purchaser again. Upon selection of a product which is not out of stock, the product is vended and the transaction is completed (134), and the transaction Credit data is added to the batch if the transaction was not conducted in real-time (136). If the Credit account is declined, the transaction is canceled (129).

If there is room for the current transaction to be stored in the batch file, then it is temporarily stored therein. Thereafter, the process proceeds by verifying other parameters about the Credit account, by comparing these parameters to data stored locally in memory at the particular vending site. For example, the Credit account number is compared to known Credit card numbering schemes as well as if the card is unexpired (140). That is, the Credit card number is checked to see if the data conforms to the appropriate numbering schemes for the particular card. For example, each type of Credit card generally includes four sets of four digit numbers, resulting in a set of 16 number digits, with the first four numbers corresponding to the type of card (e.g., American Express, Discover, MasterCard, Visa—Visa, first four numbers must be 4271, or 4226, etc). If the card account fails to conform to any known numbering scheme, or is expired, the card is declined (146). If the card account passes, then the card account number is compared to known Credit accounts that have been stolen or lost (142). Lost or stolen account numbers are also stored locally in a memory in the vending machine, and is updated periodically (e.g., during batch processing). If the Credit account is matched against a lost or stolen account, then the transaction proceeds in real time since the data contained in the lost and stolen Credit account memory may not be current (i.e., the card was incorrectly listed as stolen/lost). If the account is then declined, then a “Denied” message is displayed to the purchaser. If approved, then the “Make Selection” (130) indicator is displayed to the purchaser and the process outlined above is followed.

If the Credit account is not listed in the lost and stolen accounts data, then the Credit account is checked against recent purchases on the vending machine (144). If the Credit account was recently used for purchases, the purchases have exceeded a predetermined amount (of product and/or fees), and the batch containing the previous transactions responsible for the given amount has not been uploaded, then the Credit approval proceeds via real-time and follows step (148). The card may also be declined (152)

If the Credit account has not exceeded the periodic limit, then the “Make Selection” is displayed to the purchaser, and the transaction proceeds through steps (144). At any time during the transaction, if the customer presses the “Coin Return”, the vending transaction is cancelled (156).

It is important to note the following regarding the system and method according to the present invention:

At any point during the transaction, but prior to a product actually being vended to the purchaser, there is a time-out condition in which the transaction is canceled due to inactively over a predetermined period of time by the purchaser (or the vending machine if the transaction is conducted in real time). This is shown in the attached figure, for example, as reference numerals 150 and 154.

Any temporary storage of a Credit account/transaction in the batch memory (prior to being filled) is permanently stored therein if a product is ultimately dispensed to the purchaser. If a product is not dispensed because the card is, for example, stolen, then the transaction is deleted out of temporary storage in the batch memory. Batch memory erased upon upload.

Each and every event, including transactions and all associated data, incomplete transactions, errors, and RSSI checks (wireless signal strength) are logged into an event log.

### Credit Approvals and Settlement of Transactions

Once the remote computer receives the Credit transaction information from the vending machine, the information is forwarded to the appropriate Credit card processor host to obtain Credit approvals. The transactions are then later settled in one of three ways:

(1) the remote computer may resend a complete batch of the transactions for the particular Credit card processor;

(2) the remote computer may send a command to settle a “batch” of transactions; or

(3) no further action is necessary since the particular Credit card processor will automatically settle all transactions received

Preferably, settlement is automatically carried out upon the occurrence of a triggering event via software code without intervention by control personnel. Triggering events may include after a predetermined number of transactions have occurred, upon the occurrence of a large transaction, or upon the passage of a predetermined period of time (e.g., hourly, daily, weekly). Preferably, settlement occurs on a daily basis.

### Other Point-Of-Sale/Usage Devices

The present invention is not limited to use with vending machine devices. The Enabler may easily be configured to operate with other point-of-sale/usage devices, say, for example, a taxi metering device. With such point-of-sale/usage devices, telemetry and Credit data may be automatically forwarded to the remote computer and not transmitted using the batch method.

The Enabler for such applications as the taxi meter and other point-of-sale/usage terminals, need only include a mother-board having the wireless data transceiver and memory with appropriate software code for carrying out Credit approval processes, and an interface for connection of the Enabler to the device. A card reader is linked to the mother board for entering Credit Transaction data.

For other point-of-sale/usage devices, Credit transaction data, which may also include data associated with the service (e.g., transportation), are forwarded to the remote computer immediately after the Credit data is input into the device. The Enabler forwards the data to the remote computer which then contacts and forwards the Credit transaction data to the appropriate Credit card processor host in order to obtain a Credit approval. Once the remote computer receives the approval from the Credit card processor host, the approval is transmitted back to the Enabler which notifies the taxi driver that the transaction has been approved.

Thereafter, the point-of-sale/usage device need not re-send the Credit transaction data or send a command to the Credit card processor host to settle the transactions. The transactions may be settled by the remote computer according to the previous explanation (or automatically settled by the Credit card processor host).

Having described the invention with reference to the presently preferred embodiments, it should be understood that numerous changes in creating and operating such systems and methods may be introduced without departing from the true spirit of the invention as defined in the appended claims.

What is claimed is:

1. In a DEX enabled vending machine having a vending machine controller with a DEX interface and a multi-drop-bus interface, an enabling device for enabling electronic payment for products dispensed from said vending machine and for communicating information between said vending machine and a remote computer, said Enabler comprising:
a wireless data network transceiver linked to said DEX interface;
a card reader for entering credit card account information; and
a micro-controller in communication with said transceiver and connected to said multi-drop-bus interface.

2. The vending machine according to claim 1, further comprising a display.

3. The vending machine according to claim 1, wherein said credit account reader is selected from the group consisting of: a magnetic swipe reader, a keyboard, a personal identification number pad, a microphone, and a bio-metric device.

4. The vending machine according to claim 1, further comprising at least one of a speaker and a microphone.

5. The vending machine according to claim 1, wherein said transceiver is operated on a wireless network selected from the group consisting of: a circuit switched cellular network, a packet radio network, narrowband PCS, broadband PCS, a CDPD network, a satellite network, a CDMA network and a TDMA network.

6. In a vending machine having a vending machine controller and an enabling device for enabling electronic payment for products dispensed from said vending machine and for communicating information between said vending machine and a remote computer, said Enabler comprising:
a wireless data network transceiver linked to an interface of said vending machine controller;
a card reader for entering credit card account information; and
a micro-controller in communication with said transceiver and said interface of said vending machine controller.

7. The vending machine according to claim 6, wherein said interface comprises a first data communications interface for communicating information between said vending machine controller and said transceiver and a second interface for communication between said micro-controller and said vending machine controller.

8. A system for managing information from a vending machine comprising:
a remote computer having a database for storing information obtained from a DEX enabled vending machine, said remote computer in communication with a computer network;
a wireless data network in communication with said computer network;
a DEX enabled vending machine including:
a vending machine controller for managing operation of the vending machine and having memory for storing information related to the operation of said vending machine and information related to at least one of the inventory of vended product and sales of the vended product;
a DEX interface for transferring audit data from said vending machine controller;
a multi-drop-bus for connection of peripheral devices to said vending machine controller;
an Enabler device comprising:
a wireless data network transceiver linked to said DEX interface;
a card reader for entering credit card account information, said reader in communication with said transceiver; and
a micro-controller in communication with said transceiver and connected to said multi-drop-bus interface.

9. The system according to claim 8, further comprising a display.

10. A system for managing information from a vending machine comprising:
a remote computer having a database for storing information obtained from a vending machine, said remote computer in communication with a computer network;
a wireless data network in communication with said computer network;
a vending machine including:
a vending machine controller for managing operation of the vending machine and having memory for storing information related to the operation of said vending machine and information related to at least one of the inventory of vended product and sales of the vended product;
an interface for transferring data from said vending machine controller;
an Enabler device including:
a wireless data network transceiver linked to said interface;
a card reader for entering credit card account information, said reader in communication with said transceiver; and
a micro-controller in communication with said transceiver and said vending machine controller.

11. The system according to claim 10, wherein said interface comprises a first interface for communicating information between said transceiver and vending machine controller, and a second interface linking said micro-controller to said vending machine controller for transferring vend approval and vend denied information as a result of the input of a credit account for the purchase of vended product.

12. The system according to claim 11, wherein said first interface comprises a DEX interface and said second interface comprises a multi-drop interface.

13. A method for monitoring inventory in a vending machine comprising:
providing a vending machine having a vending machine controller including a memory for storing transaction information, said vending machine capable of vending preloaded product having a unique identification from a known inventory of said product and having a predetermined selling price, wherein in response to a request from a buyer and upon tendering payment equal to or greater than said predetermined selling price, said vending machine having the capability to create data representative of said unique product identification, and the time of any vending event, and method of payment of such event;
providing a communication link between said vending machine and a remote computer on a computer network via a wireless data network
creating a data record of all vending events, storing a plurality of said data records in said memory;
transmitting said plurality of data records to said remote computer via said wireless data network.

14. The method according to claim 13, wherein said plurality of data records is transmitted to said remote computer via said wireless network in response to a request from said remote computer.

15. The method according to claim 13, wherein said plurality of data records is transmitted to said remote computer via said wireless network in response to a request from a service technician.

16. The method according to claim 13, further comprising processing said plurality of data records at said remote computer to produce an output representative of a vending history of said vending machine.

17. The method according to claim 16, wherein said vending history includes data related to credit transaction information.

18. The method according to claim 16, wherein said vending history includes data related to errors of said vending machine.

19. The method according to claim 16, wherein said vending history includes a status of the inventory of said product in said vending machine.

20. A method for managing information from a vending machine comprising:
sending a first request from a remote computer on a computer network to a remote vending machine, said request for vending machine data stored in a database in said vending machine and said first request is sent to said vending machine via a wireless data network;
forwarding said data from said vending machine to said remote computer in response to said request.

21. The method according to claim 20, further comprising sending a second request from said remote computer to said vending machine after said data has been forwarded, said second request for clearing said database of said vending machine data.

22. A method for updating a product database in a remote vending machine comprising:
providing a vending machine having a vending machine controller in communication with a wireless transceiver for communicating with a remote computer on a computer network via a wireless data network;
sending a command from said remote computer to said vending machine, said command for changing writable fields of said database with new information;
sending said new information from said remote computer; and
storing said new information in said writable fields.

23. A method of settling a credit transaction from a point of sale device comprising:
entering credit account information into a point of sale machine for conducting a purchasing transaction for a product and/or service;
authenticating said account information;
upon said account information being authentic, said method further comprises determining the availability of memory space to store transaction information necessary to settle said transaction with a credit company issuing said credit account;
storing said transaction information necessary to settle said transaction in said memory space when said memory space is available;
settling said transaction with said credit company at a predetermined later time.

24. The method according to claim 23, wherein transaction information necessary to settle said transaction comprises said credit account information, product and/or service purchased, and time of said purchase.

25. The method according to claim 24, wherein said time comprises a date.

26. The method according to claim 24, wherein said time comprises a date and time.

27. The method according to claim 23, wherein transaction information for a plurality of earlier transactions is stored in said memory space, and wherein settling of said transaction comprises forwarding said transaction information to a remote computer.

28. The method according to claim 27, wherein after said transaction information has been forwarded to said remote computer, said remote computer forwards necessary transaction information to said credit company via said computer network.

29. The method according to claim 23, wherein when said memory space is unavailable, settlement of said transaction with said credit company is conducted during said transaction.

30. The method according to claim 23, wherein said authenticating step comprises comparing said credit account information against a database of known numbering schemes for credit account numbers.

31. The method according to claim 23, wherein said authenticating step comprises comparing said credit account information against a database of lost or stolen account numbers.

32. The method according to claim 23, wherein said authenticating step comprises determining if said credit account information is expired.

33. The method according to claim 23, wherein said authenticating step comprises determining if said credit account has been used for purchases on said vending machine greater than a predetermined amount over a predetermined period of time.

34. The method according to claim 33, wherein said predetermined amount comprises a predetermined amount of money.

35. The method according to claim 33, wherein said predetermined amount comprises a predetermined number of product.

36. The method according to claim 23, wherein said later predetermined time comprises a time it takes until said memory space is unavailable.

37. A computer readable medium having computer-executable instructions for performing a method comprising:
sending a first request from a remote computer on a computer network to a remote vending machine, said request for vending machine data stored in a database in said vending machine and said first request is sent to said vending machine via a wireless data network;
forwarding said data from said vending machine to said remote computer in response to said request.

38. A computer readable medium having computer executable instructions for performing a method for updating a product database in a remote vending machine comprising:
providing a vending machine having a vending machine controller in communication with a wireless transceiver for communicating with a remote computer on a computer network via a wireless data network;
sending a command from said remote computer to said vending machine, said command for changing writable fields of said database with new information;
sending said new information from said remote computer; and
storing said new information in said writable fields.

39. A computer readable medium having computer-executable instructions for settling a credit transaction from a point of sale device comprising:
entering credit account information into a point of sale machine for conducting a purchasing transaction for a product and/or service;
authenticating said account information;
upon said account information being authentic, said method further comprises determining the availability of memory space to store transaction information necessary to settle said transaction with a credit company issuing said credit account;
storing said transaction information necessary to settle said transaction in said memory space when said memory space is available;
settling said transaction with said credit company at a predetermined later time.

40. In a point of sale device having a controller and an enabling device for enabling electronic payment for purchases from said point of sale device and for communicating information between said point of sale device and a remote computer, said Enabler comprising:
a wireless data network transceiver linked to an interface of said controller;
a card reader for entering credit card account information, said reader in communication with said transceiver; and
a micro-controller in communication with said transceiver and said interface of said controller.

41. A system for managing information from a point-of-sale device comprising:
a remote computer having a database for storing information obtained from a point of sale device, said remote computer in communication with a computer network;
a wireless data network in communication with said computer network;
a point of sale device including:
a controller for managing operation of the point of sale device and having memory for storing information related to the operation of said point of sale device and information related to purchases of a product and/or service;
an interface for transferring data from said controller;
an Enabler device comprising:
a wireless data network transceiver linked to said interface;
a card reader for entering credit card account information, said reader in communication with said transceiver; and
a micro-controller in communication with said transceiver and said controller.

42. A method for managing information from a point of sale device comprising:
sending a first request from a remote computer on a computer network to a remote point of sale device, said request for at least one of transaction and telemetry data stored in a database in said point of sale device and said first request is sent to said point of sale device via a wireless data network;
forwarding said data from said point of sale device to said remote computer in response to said request.

43. A method of authorizing a credit transaction from a point of sale device comprising:
entering credit account information into a point of sale machine for conducting a purchasing transaction for a product and/or service;
forwarding said credit account information to a remote computer;
forwarding said credit account information from said remote computer to a credit card processor host to obtain a credit approval; and
transmitting said credit approval from said credit card processor host to said point of sale device via said remote computer.

44. The method according to claim 43, wherein said credit information is stored at said remote computer.

45. The method according to claim 43, further comprising settling said purchasing transaction with said credit card processor host by automatically forwarding a command for settling said transaction before a triggering event.

46. The method according to claim 45, wherein said triggering event comprises a predetermined time.

47. The method according to claim 43, further comprising settling said purchasing transaction with said credit card processor host by automatically forwarding a batch of a plurality of purchasing transactions to said credit card processor host before a triggering event.

48. The method according to claim 47, wherein said triggering event is a predetermined time.

49. The method according to claims 45, wherein said command is forwarded from said remote computer.

50. The method according to claims 47, wherein said command is forwarded from said remote computer.
